(19) United States
(12) Patent Application Publication
(10) Pub. No.: US 2013/0166700 A1
(43) Pub. Date: Jun. 27, 2013

(54) CONTENT DELIVERY SYSTEM, METHOD OF DELIVERING CONTENT, SERVER, CONTENT REPRODUCTION DEVICE, PROGRAM, AND RECORDING MEDIUM

(71) Applicants: Tatsuo Sudo, Osaka-shi (JP); Kazuyuki Yokogawa, Osaka-shi (JP); Tetsuya Matsuyama, Osaka-shi (JP); Kentaro Sakakura, Osaka-shi (JP)

(72) Inventors: Tatsuo Sudo, Osaka-shi (JP); Kazuyuki Yokogawa, Osaka-shi (JP); Tetsuya Matsuyama, Osaka-shi (JP); Kentaro Sakakura, Osaka-shi (JP)

(73) Assignee: SHARP KABUSHIKI KAISHA, Osaka-shi, Osaka (JP)

(21) Appl. No.: 13/821,445

(22) PCT Filed: Aug. 30, 2011
(86) PCT No.: PCT/JP2011/069582

§ 371 Date: Mar. 7, 2013

(30) Foreign Application Priority Data
Sep. 9, 2010 (JP) 2010-202212

(51) Int. Cl. H04L 29/08

(52) U.S. Cl. CPC H04L 67/02
USPC 709/219

(57) ABSTRACT

A server (20) includes: a next obtaining time determining section (23) for determining a next obtaining time which is a time to next obtain update information including information specifying content which has been updated; and an update information generating section (22) for generating the update information which further includes the next obtaining time thus determined, and transmitting the update information thus generated to an electronic book terminal (10) in response to a request from the electronic book terminal (10). The electronic book terminal (10) includes: an update information obtaining section (12) for obtaining the update information from the server (20); and a next obtaining time setting section (13) for setting a time at which the update information obtaining section (12) next obtains the update information.

### TECHNICAL FIELD

The present invention relates to (i) a content delivery system for delivering content from a server to a content reproduction device and (ii) a content delivery method. The present invention also relates to a server and a content reproduction device each included in the content delivery system. Moreover, the present invention relates to (i) a program for executing the content delivery system and (ii) a recording medium.

### BACKGROUND ART

Conventionally, a push-based delivery technique and a pull-based delivery technique have been widely used as techniques for delivering content from a server to a client terminal.

The push-based delivery technique has been employed mainly for delivering an e-mail from a server to a mobile phone. Specifically, an e-mail received by a server is automatically transmitted to a mobile phone at any time without the need for the server to wait for a request from the mobile phone. The mobile phone automatically receives the e-mail at any time in a state in which the mobile phone is in operation and in communication. An example of such a technique is disclosed in Patent Literature 1.

According to the push-based delivery technique, a server can timely deliver information to a terminal. Meanwhile, the terminal needs to be turned on at all times so as to timely receive the information without fail.

In contrast, the pull-based delivery technique has been employed mainly for downloading various pieces of content. The pull-based delivery technique is typified by downloading of a web page. Specifically, a terminal transmits, to a server, a request to obtain a web page, and the server receives the request. The server analyzes the received request, specifies the web page which is requested to obtain, and sends the web page to the terminal. The terminal thus receives a desired web page.

A known technique obtained by elaborating the pull-based delivery technique is exemplified by a content delivery technique using update information as to content. According to this technique, a server first transmits, to a terminal, update information as to content which update information has been prepared by the server. The terminal refers to the received update information, and obtains information as to the content which information is included in the update information. Then, the terminal obtains the content from the server in accordance with the obtained information as to the content.

Use of this technique enables a user of the terminal to know, prior to downloading of pieces of content, which of the pieces of content has been updated in the server. This makes it possible to efficiently obtain a new piece of content.

Patent Literature 2 discloses an example of a technique in which such update information is delivered from a server to a terminal by the push-based delivery technique. According to the technique disclosed in Patent Literature 2, in accordance with terminal state information, a content delivery control server determines a time interval at which to deliver content update information. Then, in accordance with the time interval, the content delivery control server determines whether or not content data matching user setting information has been updated. Further, the content delivery control server generates content update information based on the content data which has been updated, and delivers the generated content update information to a terminal. The technique thus elaborated enables the terminal to appropriately receive the content update information in accordance with a type of the terminal or a network environment.

### CITATION LIST

### Patent Literature 1

Japanese Patent Application Publication, Tokukai, No. 2008-46441 A (Publication Date: Feb. 28, 2008)

### Patent Literature 2

Japanese Patent Application Publication, Tokukai, No. 2009-181386 A (Publication Date: Aug. 13, 2009)

### SUMMARY OF INVENTION

### Technical Problem

However, according to the technique disclosed in Patent Literature 2, the server regularly sends the content update information to the terminal. Therefore, the terminal needs to wait at all times to receive the content update information so as to timely receive the content update information. That is, there is a problem such that the content update—information cannot be timely delivered unless the terminal is always in an operating state.

The present invention has been made in view of the above problem, and an object of the present invention is to provide a content delivery system, a content delivery method, a server, a content reproduction device, a program, and a recording medium, the content delivery system allowing update information to be timely delivered even if the content reproduction device (a terminal) is not always in an operating state.

### Solution to Problem

In order to attain the above object, a content delivery system in accordance with the present invention includes: a server for delivering content; and at least one content reproduction device for receiving and reproducing the content delivered from the server, the server including: determination means for determining a next obtaining time which is a time to next obtain update information including information specifying the content which has been updated; generation means for generating the update information which further includes the next obtaining time thus determined; and transmission means for transmitting the update information thus generated to the at least one content reproduction device in response to a request from the at least one content reproduction device, the at least one content reproduction device including: obtaining means for obtaining the update information from the server; and setting means for setting, in accordance with the next obtaining time included in the update information thus obtained, a time at which the obtaining means next obtains the update information.

According to the above configuration, the at least one content reproduction device obtains update information from the server. The update information includes information specifying content which has been updated in the server. This allows the at least one content reproduction device to obtain the updated content from the server with the use of the information.

Note here that, according to the content delivery system, the update information includes a next obtaining time which is a time to next obtain the update information. The at least one content reproduction device sets, in accordance with the next obtaining time, a time to obtain the update information from the server. Then, at the set time, the at least one content reproduction device obtains the update information which has been renewed.

The server transmits the update information to the at least one content reproduction device in response to a request from the at least one content reproduction device to obtain the update information. That is, the server does not regularly deliver the update information to the at least one content reproduction device. However, the update information generated by the server includes a next obtaining time which is a time to next obtain the update information. Therefore, in accordance with the next obtaining time, the at least one content reproduction device can timely request the server to obtain the update information.

As has been described earlier, the content delivery system in accordance with the present invention yields an effect of timely delivering update information from the server to the at least one content reproduction device while the at least one content reproduction device actively accesses the server to obtain update information as to content. Therefore, it is possible to timely deliver update information even if the at least one content reproduction device is not always in an operating state.

In order to attain the above object, a server in accordance with the present invention is a server for delivering content to a content reproduction device which receives and reproduces the content delivered from the server, the server including: determination means for determining a next obtaining time which is a time to next obtain update information including information specifying the content which has been updated; generation means for generating the update information which further includes the next obtaining time thus determined; and transmission means for transmitting the update information thus generated to the content reproduction device in response to a request from the content reproduction device.

According to the above configuration, the server yields an operation-effect which is identical to that yielded by the content delivery system in accordance with the present invention.

In order to attain the above object, a content reproduction device in accordance with the present invention is a content reproduction device for receiving and reproducing content delivered from a server, the content reproduction device including: obtaining means for obtaining update information from the server, the update information having been transmitted from the server and including a next obtaining time which is a time to next obtain update information including information specifying the content which has been updated; and setting means for setting, in accordance with the next obtaining time included in the update information thus obtained, a time at which the obtaining means next obtains the update information.

According to the above configuration, the content reproduction device yields an operation-effect which is identical to that yielded by the content delivery system in accordance with the present invention.

In order to attain the above object, a content delivery method in accordance with the present invention is a content delivery method which is carried out by a content delivery system, the content delivery system including: a server for delivering content; and a content reproduction device for receiving and reproducing the content delivered from the server, the server carrying out the steps of: (a) determining a next obtaining time which is a time to next obtain update information including information specifying the content which has been updated; (b) generating the update information which further includes the next obtaining time determined in the step (a); and (c) transmitting the update information generated in the step (b) to the content reproduction device in response to a request from the content reproduction device, the content reproduction device carrying out the steps of: (a′) obtaining the update information from the server; and (b′) setting, in accordance with the next obtaining time included in the update information thus obtained, a time to next obtain the update information in the step (a′).

According to the above configuration, the content delivery method yields an operation-effect which is identical to that yielded by the content delivery system in accordance with the present invention.

Note that the content delivery system may be realized by a computer. In this case, (i) a program for realizing the content reproduction device in the computer by causing the computer to operate as each means of the content delivery system and (ii) a computer-readable recording medium in which the program is recorded are both encompassed in the scope of the present invention.

For a fuller understanding of the nature and advantages of the invention, reference should be made to the ensuing detailed description taken in conjunction with the accompanying drawings.

### Advantageous Effects of Invention

A content delivery system in accordance with the present invention yields an effect of timely delivering update information even if a content reproduction device (terminal) is not always in an operating state.

### BRIEF DESCRIPTION OF DRAWINGS

FIG. 1 is a block diagram illustrating a configuration of a content delivery system in accordance with the present invention.

FIG. 2 is a view illustrating how an electronic book terminal reproduces an electronic book and displays the electronic book in a display.

FIG. 3 is a flow chart showing how a process in which an electronic book terminal obtains update information from a server.

FIG. 4 is a flow chart showing how a process is carried out in which a server generates update information and transmits the update information to an electronic book terminal.

FIG. 5 shows a specific example of update information.

FIG. 6 illustrates how an electronic book terminal displays, in a display, information as to content obtainable from a server in accordance with update information.

### DESCRIPTION OF EMBODIMENTS

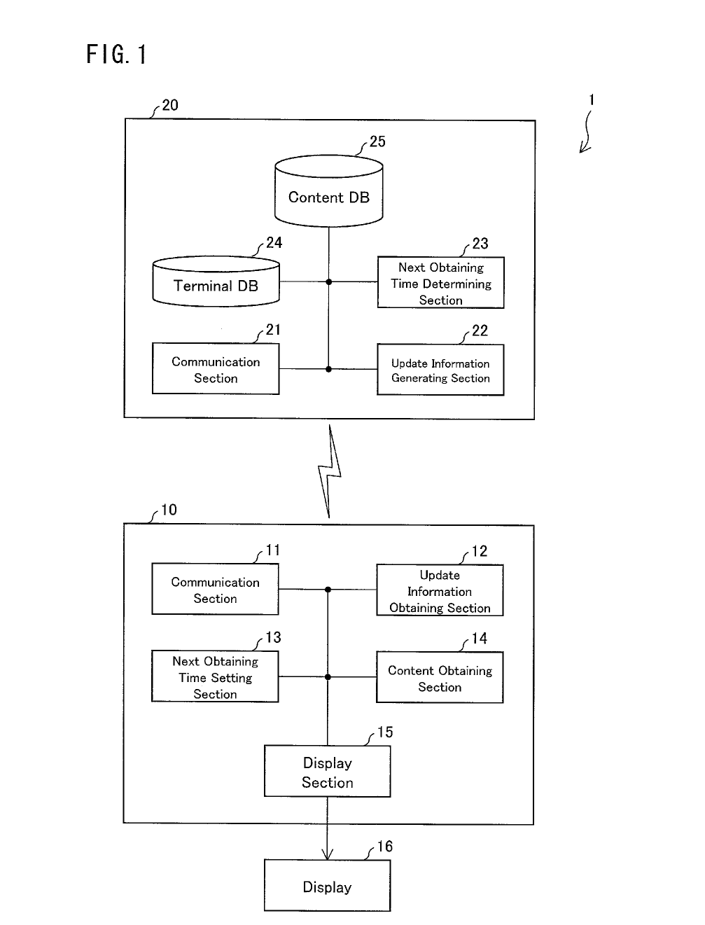

The following description discusses, with reference to FIGS. 1 to 6, a content delivery system 1 in accordance with an embodiment of the present invention.

(Configuration of Content Delivery System 1)

FIG. 1 is a block diagram illustrating a configuration of the content delivery system 1 in accordance with the present invention. The content delivery system 1 includes an electronic book terminal 10 (content reproduction device) and a server 20 (see FIG. 1).

The electronic book terminal 10 is a terminal device for reading digital electronic books such as a digital magazine, a digital newspaper, and digital a book. A user uses the electronic book terminal 10 to reproduce and read a desired electronic book. The electronic book terminal 10, which has a communication function, is capable of obtaining (downloading) a desired electronic book from the server 20. The server 20 operates a service of selling various electronic books. The user becomes a member of the service and purchases an electronic book. The electronic book thus purchased is automatically downloaded to the electronic book terminal 10 and stored in a memory of the electronic book terminal 10.

(Configuration of Electronic Book Terminal 10)

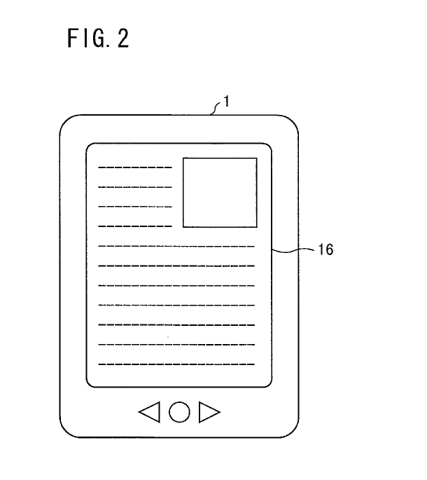

The electronic book terminal 10 includes a communication section 11, an update information obtaining section 12 (receiving means), a next obtaining time setting section 13 (setting means), a content obtaining section 14 (obtaining means), a display section 15, and a display 16. The communication means 11 communicates with the server 20 via a wireless communication line. The update information obtaining section 12 obtains update information from the server 20. The next obtaining time setting section 13 sets, in accordance with a next obtaining time included in the update information thus obtained, a time at which the electronic book terminal 10 next obtains update information. The content obtaining section 14 obtains an electronic book from the electronic book terminal 10 in accordance with content information included in the update information. The display section 15 reproduces the electronic book thus obtained and displays the electronic book on the display 16. The display 16 is exemplified by various display devices such as a liquid crystal display. FIG. 2 is a view illustrating how the electronic book terminal 10 reproduces the electronic book and displays the electronic book in the display 16.

(Configuration of Server 20)

The server 20 includes a communication section 21, an update information generating section 22 (generation means, transmission means), a next obtaining time determining section 23 (determination means), a terminal DB 24, and a content DB 25. The communication section 21 communicates with the electronic book terminal 10 via a wireless communication line. The update information generating section 22 generates update information. The next obtaining time determining section 23 determines a next obtaining time which is a time to next obtain the update information. The terminal DB 24 is a database for managing electronic book terminals 10 constituting the content delivery system 1. The content DB 25 is a database for storing and managing content which the server 20 can deliver to the electronic book terminal 10.

### (Obtainment of Content by Use of Update Information)

According to the content delivery system 1, it is possible to deliver content by use of update information as to content. Specifically, the server 20 provides, to the electronic book terminal 10, update information including information as to content which has been updated in the server 20. The electronic book terminal 10 refers to the update information provided thereto, and specifies the content which has been updated. Then, the electronic book terminal 10 obtains the content from the server 20. This enables the user of the electronic book terminal 10 to know, prior to downloading of pieces of content, which of the pieces of content has been updated in the server 20. This makes it possible to efficiently obtain a new piece of content.

The content delivery system 1 in accordance with the present embodiment is characteristic in (i) contents of update information and (ii) timing control of delivery. Therefore, the following description discusses (i) how a process for obtaining content is carried out and (ii) contents of update information.

(Process for Obtaining Update Information)

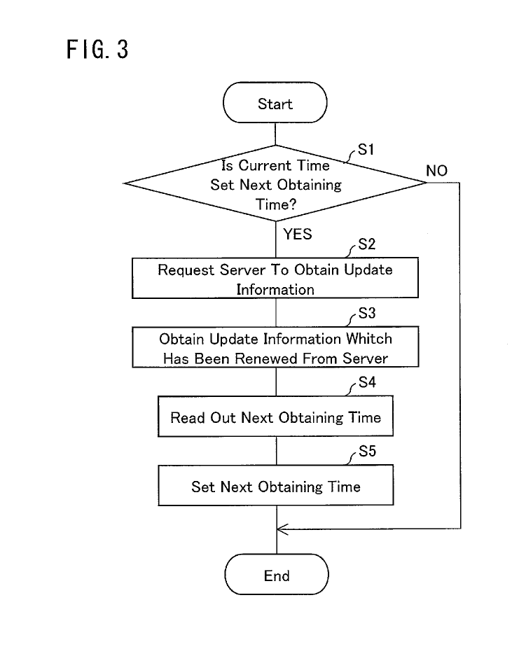

FIG. 3 is a flow chart showing how a process in which the electronic book terminal 10 obtains update information from the server 20.

First, the update information obtaining section 12 determines whether or not a current time is a set next obtaining time (step S1). When a result of the determination at step S1 is “false” (No), the process shown in FIG. 1 is ended. That is, the electronic book terminal 10 carries out nothing.

Meanwhile, when the result of the determination at step S1 is “true” (Yes), the update information obtaining section 12 transmits, to the server 20 via the communication section 11, a request to obtain update information (step S2). In this case, the update information obtaining section 12 transmits a terminal ID for identifying the electronic book terminal 10 to the server 20 so that the terminal ID is included in the request to obtain update information. In response to the request, the server 20 generates update information and transmits the update information to the electronic book terminal 10. The update information obtaining section 12 receives, from the server 20 via the communication section 11, the update information which has been renewed (step S3). The update information obtaining section 12 supplies the update information to each of the next obtaining time setting section 13 and the content obtaining section 14. The content obtaining section 14 obtains content such as an electronic book from the electronic book terminal 10 in accordance with content information included in the update information.

The next obtaining time setting section 13 reads out, from the update information, the next obtaining time included in the update information (step S4). Then, in accordance with the next obtaining time, the next obtaining time setting section 13 sets a time at which the electronic book terminal 10 next obtains the update information (step S5). In this case, the next obtaining time setting section 13 may set the time to, for example, the next obtaining time itself which has been read out. Alternatively, as described later, the next obtaining time setting section 13 may set the time to another time which is determined in accordance with the next obtaining time. Note that the next obtaining time setting section 13 may operate a given timer to set the time.

Note that the process shown in FIG. 3 is a process carried out in a case where a time to obtain the update information has already been set for the electronic book terminal 10. In a case where this time has not been set for the electronic book terminal 10, the update information obtaining section 12 may randomly determine an appropriate timing and obtain the update information at a determined timing. Alternatively, the update information obtaining section 12 may obtain the update information in response to an instruction from the user.

(Process for Generating Update Information)

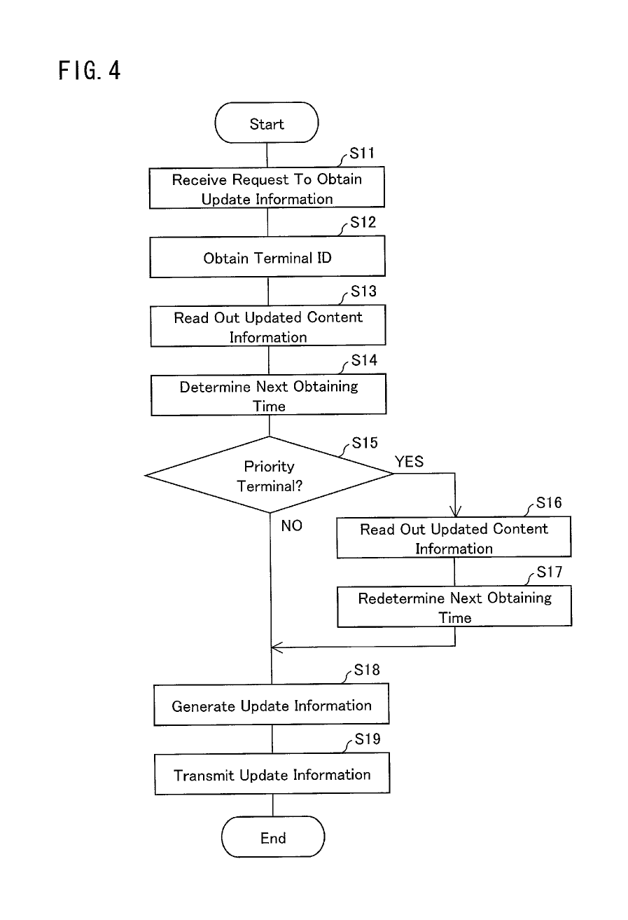

FIG. 4 is a flow chart showing how a process is carried out in which the server 20 generates update information and transmits the update information to the electronic book terminal 1.

First, a control section (not illustrated) receives, from the electronic book terminal 10 via the communication section 21, a request to obtain update information (step S11). The control section interprets the request and controls the update information generating section 22 to generate update information according to need. In this case, the control section supplies the request to the update information generating section 22. The update information generating section 22 obtains a terminal ID of the electronic book terminal 10, the terminal ID being included in the request (step S12). In this case, the update information generating section 22 searches the terminal DB 24 with the use of the terminal ID, so as to identify the electronic book terminal 10 which has transmitted the request.

Next, the update information generating section 22 reads out, from the content DB 25, updated content information as to content which is delivered to all electronic book terminals 10 in common (step S13). The content which is delivered in common herein refers to content to be uniformly provided to all members that use a service based on the content delivery system 1 (e.g., recommended information from the service and a notice of maintenance of the server 20). The update information generating section 22 supplies the updated content information to the next obtaining time determining section 23.

Next, the next obtaining time determining section 23 determines a next obtaining time which is a time at which the electronic book terminal 10 next obtains the update information (step S14). In this case, it is possible to determine the next obtaining time in accordance with the updated content information. For example, the next obtaining time determining section 23 determines that the next obtaining time is a time at or after a time at which content indicated by the updated content information becomes available to be delivered. A method for determining the next obtaining time is exemplified by various methods other than the above method, to which the present embodiment is not limited.

Next, the update information generating section 22 determines whether or not the electronic book terminal 10 is a priority terminal (step S15). Note here that, assuming that the user has a plurality of electronic book terminals 10, the priority terminal refers to one of the plurality of electronic book terminals 10. That is, the user, who can receive an identical service with the use of the plurality of electronic book terminals 10, is allowed to download specific content (i.e. subscription content) merely with the use of one of the plurality of electronic book terminals 10. The one of the plurality of electronic book terminals 10 is the priority terminal.

In the terminal DB 24, information (priority terminal information) indicative of whether or not the electronic book terminal 10 is the priority terminal is stored so that the information is associated with the terminal ID. Therefore, in the step S15, the update information generating section 22 uses the terminal ID to search the terminal DB 24 for the priority terminal information, and determines, in accordance with the priority terminal information, whether or not the electronic book terminal 10 is the priority terminal.

When a result of the determination at the step S15 is “true” (Yes), the update information generating section reads out the updated content information as to subscription content from the content DB 25 (step S16). The subscription content herein refers to information indicative of an electronic book to which the user of the electronic book terminal 10 regularly subscribes. Examples of such an electronic book include a newspaper and a magazine. According to the present embodiment, the user of the electronic book terminal 10 subscribes to a magazine.

The update information generating section 22 supplies the updated content information thus read out to the next obtaining time determination section 23. In accordance with the updated content information, the next obtaining time determination section 23 redetermines the next obtaining time (step S17). That is, the next obtaining time determining section 23 determines an optimum next obtaining time in accordance with the information as to the subscription content. For example, assume that the next obtaining time determined at the step S14 is after 10 days from a current time. Meanwhile, assume that a next issue of a newspaper to which the user subscribes becomes available to be downloaded after five hours. In this case, the next obtaining time determining section 23, which once determined that the next obtaining time was after 10 days, redetermines, in accordance with a scheduled time of downloading of the magazine, that the next obtaining time is after five hours from the current time. This makes it possible to determine an appropriate next obtaining time in accordance with a type of content information included in update information.

The next obtaining time determining section 23 notifies the update information generating section 22 of the next obtaining time thus determined. The update information generating section 22 generates update information (step S18). Specifically, the update information generating section 22 generates update information including the content information which has been read out from the content DB 25 (the updated content information as to the content which is delivered in common and the updated content information as to the subscription content), and further including the next obtaining time. Thereafter, the update information generating section 22 transmits the generated update information to the electronic book terminal 10 via the communication section 21 (step S19). The electronic book terminal 10 thus obtains, from the server 20, the update information which the electronic book terminal 10 has requested of the server 20.

Note that, when a result of the determination at the step S15 is “false” (No), the update information generating section 22 generates update information including (i) the updated content information as to the content which is delivered in common and (ii) the next obtaining time (step S18).

(Example of Update Information)

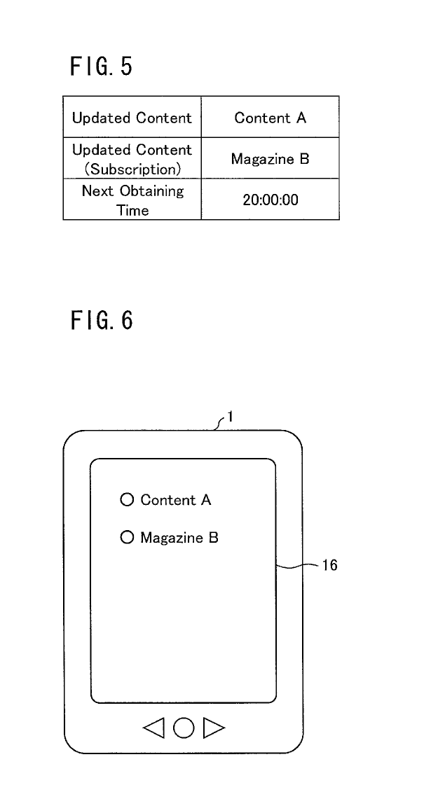

FIG. 5 shows a specific example of update information. According to the specific example shown in FIG. 5, the update information includes information (content information) specifying two pieces of updated content. That is, the update information includes (i) a name of content A which is updated content to be delivered in common and (ii) a name of a magazine B which is updated content to regularly subscribe to. The update information further includes, for each of the two pieces of updated content, information (e.g., a URL and an ID) necessary for downloading the two pieces of updated content (not illustrated). The update information may be data in any format. The update information may be data in, for example, an XML (eXtensible Markup Language) format.

The electronic book terminal 10 can automatically obtain, from the server 20 without the need to wait for a selection operation by a user, pieces of content which have been specified by content information included in update information which the electronic book terminal 10 has obtained. In order to obtain these pieces of content from the server 20, the electronic book terminal 10 transmits, to the server 20, the content information included in the update information, so as to indicate, to the server 20, which of the pieces of content is desired to obtain. This causes the server 20 to transmit the indicated piece of content to the electronic book terminal 10. The electronic book terminal 10 thus obtains the pieces of content which has been updated in the content from the server 20 with reference to the update information.

(Display of Update Information)

The electronic book terminal 10 not only automatically obtains content but also can obtain content from the server 20 in response to a selection operation by a user, i.e., in response to indication of the content by a user. FIG. 6 illustrates how the electronic book terminal 10 displays, in the display 16, information as to content obtainable from the server 20 in accordance with update information. According to the example illustrated in FIG. 6, the content reproduction device displays, in the display 16, the content information included in the update information shown in FIG. 5. That is, the content reproduction device displays the information as to the content A (the name of the content A) and the information as to the magazine B (the name of the magazine B). The user who has checked the display recognizes that these pieces of content have been newly updated. Then, the user operates the electronic book terminal 10, and selects a piece of content which piece the user desires to obtain. This allows content of the electronic book terminal 10 to obtain the selected piece of content from the server 20.

(Operation-Effects)

As has been described earlier, the electronic book terminal 10 obtains update information from the server 20. The update information includes information specifying content which has been updated in the server. This allows the electronic book terminal 10 to obtain the updated content from the server 20 with the use of the information.

Note here that, according to the content delivery system 1, the update information includes a next obtaining time which is a time to next obtain the update information. The electronic book terminal 10 sets, in accordance with the next obtaining time, a time to obtain the update information from the server. Then, at the set time, the electronic book terminal 10 obtains the update information which has been renewed.

The server 20 transmits the update information to the electronic book terminal 10 in response to a request from the electronic book terminal 10 to obtain the update information. That is, the server 20 does not regularly deliver the update information to the electronic book terminal 10. However, the update information generated by the server 20 includes a next obtaining time which is a time to next obtain the update information. Therefore, in accordance with the next obtaining time, the electronic book terminal 10 can timely request the server 20 to obtain the update information.

As has been described earlier, the content delivery system 1 in accordance with the present embodiment makes it possible to timely deliver update information from the server 20 to the electronic book terminal 10 while the electronic book terminal 10 actively accesses the server to obtain update information as to content. Therefore, it is possible to timely deliver update information even if the content reproduction device 10 is not always in an operating state.

The present invention is not limited to the description of the embodiments above, but may be altered by a skilled person within the scope of the claims. An embodiment based on a proper combination of technical means disclosed in different embodiments is encompassed in the technical scope of the present invention. The following description discusses some possible modified examples.

(Example of Determination of Next Obtaining Time)

The content delivery system 1 is originally configured on the assumption that electronic book terminals 10 large in number access the server 20. In this case, it is preferable that the next obtaining time determining section 23 determines a next obtaining time which varies in accordance with each of the electronic book terminals 10. This makes it possible to prevent a plurality of electronic book terminals 10 from simultaneously obtaining update information at the same time. Therefore, it is possible to reduce communication congestion.

The next obtaining time determining section 23 may determine that the next obtaining time is a time after a given interval. For example, the next obtaining time determining section 23 determines that the next obtaining time is a time after 24 hours from a current time. This enables the electronic book terminal 10 to obtain update information at regular intervals.

The next obtaining time determining section 23 may determine that the next obtaining time is a time at or after a time at which content becomes obtainable from the server 20. This enables the electronic book terminal 10 to obtain the content at an appropriate timing from the server 20.

The next obtaining time determining section 23 may determine that the next obtaining time is a time after a given time interval from a scheduled time at which content is to be posted to the server 20. The following description takes, as an example, a case where content to be delivered is a newspaper, and more specifically discusses how to determine the next obtaining time.

First, a time (e.g., 4:00 a.m.) is specified at which a newspaper publisher is to post a morning newspaper to the server 20. Then, as to update information to be delivered to an electronic book terminal 10 owned by a user who subscribes to the morning newspaper, the update information generating section 22 randomly determines that the next obtaining time is any time between 4:00 a.m. and 5:00 a.m.

Alternatively, the next obtaining time can be determined differently between a premium user and a common user other than the premium user. Specifically, it is determined, for the premium user, that the next obtaining time is any time between 4:00 a.m. and 4:30 a.m. whereas, it is determined, for the common user, that the next obtaining time is a time after 4:30 a.m.

In this case, even if the common user manually accesses the server 20 between 4:00 a.m. and 4:30 a.m., update information obtainable at that time does not include information (an entry) specifying the morning newspaper. This prevents the common user from obtaining the morning newspaper. In contrast, the premium user can obtain the morning newspaper. Note that the common user can also obtain the morning newspaper at or after 4:30 a.m., at which the entry of the morning newspaper is added to update information for the common user.

Alternatively, the next obtaining time determining section 23 may determine the next obtaining time differently between a user who subscribes to the morning newspaper and a user who does not subscribe to the morning newspaper. As has been described earlier, the server 20 is subjected to access concentration for obtaining data of the morning newspaper during an early-morning period (from 4:00 a.m. to 5:00 a.m.). Accordingly, for the user who does not subscribe to the morning newspaper, the update information generating section 22 sets the next obtaining time to a period other than the early-morning period.

(Distribution of Access Period)

Update information itself is much smaller in data size than content to be downloaded. In view of this, the server 20 can equalize a load on the server by changing a timing at which to cause update information to include an entry of content.

For example, the server 20 separately delivers pieces of less urgent information (such as recommended content from a service) over several days. Specifically, all users are divided into several groups in an ascending order of the first character of a character string of a user account. On the first day, the server 20 causes update information to include an entry of recommended content for users belonging to the first group. On the next day, a similar process is carried out with respect to the next group.

Further, the server 20 may cause update information to include an entry of regularly delivered (subscription) content to be delivered to a premium user during a period in which accesses to the server 20 concentrate, whereas the server 20 may cause update information to be delivered to a common user during that period to include no entry of the regularly delivered content. According to this, during the period in which accesses to the server 20 concentrate, the premium user can obtain the regularly delivered content, whereas the common user cannot obtain the regularly delivered content. Note that, in a case where accesses to the server 20 heavily concentrate due to unexpected circumstances, the server 20 may remove the entry of the regularly delivered content from the update information to be delivered to the premium user.

The update information generating section 22 can change, for each electronic book terminal 10, a timing at which to generate update information. In this case, update information as to identical content is delivered to electronic book terminals 10 at respective different timings. This makes it possible to prevent the electronic book terminals 10 from simultaneously obtaining identical content at the same time. That is, it is possible to prevent concentration of accesses to the server 20.

(Resetting of Time by Update Information Generating Section 22)

Assume that the update information obtaining section 12 attempted to obtain update information at an originally set time (a time set by the server 20) but was not able to obtain the update information due to a network connection error or the like. In this case, the next obtaining time setting section 13 resets a time to obtain the update information to a time after a given time from a currently-set next obtaining time.

Assume that the electronic book terminal 10 is not in an AC-charged state at a scheduled time to obtain update information. Note here that, when an electronic book terminal 10 has a remaining battery level which is not more than a specified standard value, the update information obtaining section 12 does not obtain the update information at the scheduled time. Note also that the next obtaining time setting section 13 resets a time to obtain the update information to a time after a given time from a currently-set time.

(Reduction of Electric Power Consumption in Electronic Book Terminal 10)

The electronic book terminal 10 may operate in a mode in which the electronic book terminal 10 consumes less electric power during a period from when the electronic book terminal 10 obtains update information to a set time. In this case, the electronic book terminal 10 can timely receive update information while consuming less electric power.

The electronic book terminal 10 may be turned off during a period from when the electronic book terminal 10 obtains update information to a set time. In this case, the electronic book terminal 10 which does not always operate can also timely receive update information while consuming the least amount of electric power.

(Program and Recording Medium)

Namely, the content delivery system 1 includes (i) a CPU which executes a command of a program that implements each function of the content delivery system 1, (ii) a ROM (Read Only Memory) in which the program is stored, (iii) a RAM (Random Access Memory) which extracts the control program in executable form, and (iv) a storage device (a recording medium) such as a memory in which the program and various sets of data are stored. Such an arrangement allows the object of the present invention to be attained also by a given recording medium.

It is only necessary that program codes (an executable program, an intermediate code program, and a source program) of the program of the content delivery system 1 which is software that implements the each function be computer-readably recorded in such a recording medium. The recording medium is supplied to the content delivery system 1. It is only necessary that the content delivery system 1 serving as a computer (or a CPU or an MPU) read and carry out the program codes recorded in the recording medium thus supplied thereto.

The recording medium which supplies the program codes to the content delivery system 1 is not limited to a recording medium of a specific structure or type. Namely, examples of the recording medium include (i) tapes such as a magnetic tape and a cassette tape, (ii) disks including magnetic disks such as a floppy (Registered Trademark) disk and a hard disk, and optical disks such as a CD-ROM, an MO, an MD, a DVD, and a CD-R, (iii) cards such as an IC card (including a memory card) and an optical card, and (iv) semiconductor memories realized by a mask ROM, EPROM, EEPROM, a flash ROM, and the like.

The object of the present invention can also be achieved by allowing the content delivery system 1 to be connected to a communication network. In this case, the program codes are supplied to the content delivery system 1 via a communication network. It is only necessary that the communication network be capable of supplying the program codes to the content delivery system 1. The communication network is not limited to a communication network of a specific type or form. Examples of the communication network includes the Internet, an intranet, an extranet, a LAN, ISDN, VAN, a CATV communications network, a virtual private network, a telephone network, a mobile telecommunications network, and a satellite communication network.

A transmission medium of which a communication network is composed is not particularly limited. Examples of the transmission medium includes wired transmission media such as IEEE 1394, a USB (Universal Serial Bus), a power-line carrier, a cable TV circuit, a telephone line, and ADSL (Asymmetric Digital Subscriber Line) and wireless transmission media such as infrared communication systems such as IrDA and a remote controller, Bluetooth (Registered Trademark), 802.11 wireless communication system, HDR, a mobile phone network, a satellite circuit, and a digital terrestrial network. Note that the present invention can also be realized in a form of a computer data signal in which the program codes are embodied by an electronic transmission and which is embedded in carrier waves.

### SUMMARY OF EMBODIMENT

As has been described earlier, the content delivery system is preferably arranged such that: the at least one content reproduction device of the content delivery system includes a plurality of content reproduction devices; and the determination means determines the next obtaining time which varies in accordance with each of the plurality of content reproduction devices.

According to the above configuration, it is possible to prevent a plurality of content reproduction devices from simultaneously obtaining update information at the same time. Therefore, it is possible to reduce communication congestion.

Further, it is preferable that the determination means determines that the next obtaining time be a time after a given time interval from a current time.

The above configuration enables the at least one content reproduction device to obtain update information at regular intervals.

Further, it is preferable that the determination means determines that the next obtaining time be a time at or after a time at which the content becomes obtainable from the server.

The above configuration enables the at least one content reproduction device to obtain the content at an appropriate timing from the server.

Further, it is preferable that the at least one content reproduction device of the content delivery system include a plurality of content reproduction devices; and the generation means changes, for each of the plurality of content reproduction devices, a timing at which to generate the update information.

According to the above configuration, update information as to identical content is delivered to content reproduction devices at respective different timings. This makes it possible to prevent the content reproduction devices from simultaneously obtaining identical content at the same time. That is, it is possible to prevent concentration of accesses to the server.

Further, it is preferable that the at least one content reproduction device operate in a mode in which the at least one content reproduction device consumes less electric power during a period from when the at least one content reproduction device obtains the update information to the set time.

According to the above configuration, the at least one content reproduction device can timely receive update information while consuming less electric power.

Further, it is preferable that the at least one content reproduction device be turned off during a period from when the at least one content reproduction device obtains the update information to the set time.

According to the above configuration, the at least one content reproduction device which does not always operate can also timely receive update information while consuming the least amount of electric power.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be widely used as a content delivery system for delivering various pieces of content such as an electronic book.

### REFERENCE SIGNS LIST

1 Content delivery system
10 Electronic book terminal (content reproduction device)
11 Communication section
12 Update information obtaining section (receiving means)
13 Next obtaining time setting section (setting means)
14 Content obtaining section (obtaining means)
15 Display section
16 Display
20 Server
21 Communication section
22 Update information generating section (generation means, transmission means)
23 Next obtaining time determining section (determination means)
24 Terminal DB
25 Content DB

1. A content delivery system comprising:
a server for delivering content; and
at least one content reproduction device for receiving and reproducing the content delivered from the server,
the server including:
determination means for determining a next obtaining time which is a time to next obtain update information including information specifying the content which has been updated;
generation means for generating the update information which further includes the next obtaining time thus determined; and
transmission means for transmitting the update information thus generated to the at least one content reproduction device in response to a request from the at least one content reproduction device,
the at least one content reproduction device including:
obtaining means for obtaining the update information from the server; and
setting means for setting, in accordance with the next obtaining time included in the update information thus obtained, a time at which the obtaining means next obtains the update information.

2. The content delivery system as set forth in claim 1, wherein:
the at least one content reproduction device of the content delivery system includes a plurality of content reproduction devices; and
the determination means determines the next obtaining time which varies in accordance with each of the plurality of content reproduction devices.

3. The content delivery system as set forth in claim 1, wherein the determination means determines that the next obtaining time is a time after a given time interval from a current time.

4. The content delivery system as set forth in claim 1, wherein the determination means determines that the next obtaining time is a time at or after a time at which the content becomes obtainable from the server.

5. The content delivery system as set forth in claim 1, wherein:
the at least one content reproduction device of the content delivery system includes a plurality of content reproduction devices; and
the generation means changes, for each of the plurality of content reproduction devices, a timing at which to generate the update information.

6. The content delivery system as set forth in claim 1, wherein the at least one content reproduction device operates in a mode in which the at least one content reproduction device consumes less electric power during a period from when the at least one content reproduction device obtains the update information to the set time.

7. The content delivery system as set forth in claim 6, wherein the at least one content reproduction device is turned off during a period from when the at least one content reproduction device obtains the update information to the set time.

8. A server for delivering content to a content reproduction device which receives and reproduces the content delivered from the server,
said server comprising:
determination means for determining a next obtaining time which is a time to next obtain update information including information specifying the content which has been updated;
generation means for generating the update information which further includes the next obtaining time thus determined; and
transmission means for transmitting the update information thus generated to the content reproduction device in response to a request from the content reproduction device.

9. A content reproduction device for receiving and reproducing content delivered from a server,
said content reproduction device comprising:
obtaining means for obtaining update information from the server, the update information having been transmitted from the server and including a next obtaining time which is a time to next obtain update information including information specifying the content which has been updated; and
setting means for setting, in accordance with the next obtaining time included in the update information thus obtained, a time at which the obtaining means next obtains the update information.

10. (canceled)

11. A program for causing a content delivery system as set forth in claim 1 to operate, the program causing a computer to function as each means of the content delivery system.

12. A computer-readable recording medium in which the program as set forth in claim 11 is recorded.
